(19) United States
(12) Patent Application Publication
(10) Pub. No.: US 2015/0120826 A1
(43) Pub. Date: Apr. 30, 2015

(54) NODE CONTROL IN A DISTRIBUTED PEER-TO-PEER NETWORK

(71) Applicants: Bernd Gauweiler, London (GB); Richard A. Blomseth, San Jose, CA (US)

(72) Inventors: Bernd Gauweiler, London (GB); Richard A. Blomseth, San Jose, CA (US)

(21) Appl. No.: 14/065,176

(22) Filed: Oct. 28, 2013

(51) Int. Cl. H04L 29/08

(52) U.S. Cl. CPC H04L 67/104
USPC 709/204

(57) ABSTRACT

Embodiments of the invention include a method and system for improved node control in a distributed peer-to-peer network. The invention provides a framework component which automatically converts and conditions incoming data from other nodes, regardless of their type. The data is converted from a network compatible format to an application compatible format based upon stored data type definitions. The data is further conditioned based on stored data property rules. Thus, once the data reaches the application, it is already properly formatted. The application component which runs on the device hardware is greatly simplified through the use of this framework component.

### FIELD

The embodiments of the invention are related to the field of node control, especially for nodes in a peer-to-peer network.

### BACKGROUND

Distributed peer-to-peer control networks possess several characteristic requirements which provide a unique challenge to creators of devices and applications for use in peer-to-peer control networks. Control networks must handle data that arrives in a non-deterministic schedule, representing a diversity of physical, logical, or abstract entities. Control networks must also recognize semantics of the arriving data. Peers in the control network must agree upon all these factors for data shared between them. To reach such an agreement, peers in a control network either carry all metadata required to enable receivers to fully understand any data they might encounter, or to ensure that data only reaches receivers with a previously established agreement. This poses a significant challenge to the application developer and the person integrating multiple control devices into one distributed peer-to-peer control network. The application developer generally needs significant in-depth knowledge in the processes, protocols and procedures involved to develop an application that correctly processes the incoming and outgoing data. The person integrating multiple devices into one such network needs to understand each devices' attributes and capabilities in order to combine only those devices that are compatible.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to affect such feature, structure, or characteristic in connection with other embodiments whether or not explicitly described.

FIG. 1 illustrates an exemplary control network featuring four nodes with each node associated with an application.

FIG. 2 illustrates the processing of data in a node according to an embodiment of the invention.

FIG. 3 is a block diagram of the framework component utilized by a node according to one embodiment.

FIG. 4 illustrates resource definition types according to one embodiment of the invention.

FIG. 5 illustrates an assembly data object used to establish a contract between different nodes according to one embodiment of the invention.

FIG. 6 is a flow diagram illustrating the details of contract formation between two devices according to one embodiment of the invention.

FIG. 7 is a flow diagram illustrating data processing according to one embodiment of the invention.

FIG. 8 illustrates instantiated stored profiles which have been called by the application component according to one embodiment of the invention.

FIG. 9 is a flow diagram illustrating the processing of application upgrades according to one embodiment of the invention.

FIG. 10 illustrates, in block diagram form, an exemplary processing system such as a device or a node.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated by one skilled in the art that the invention may be practiced without such specific details. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described. In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

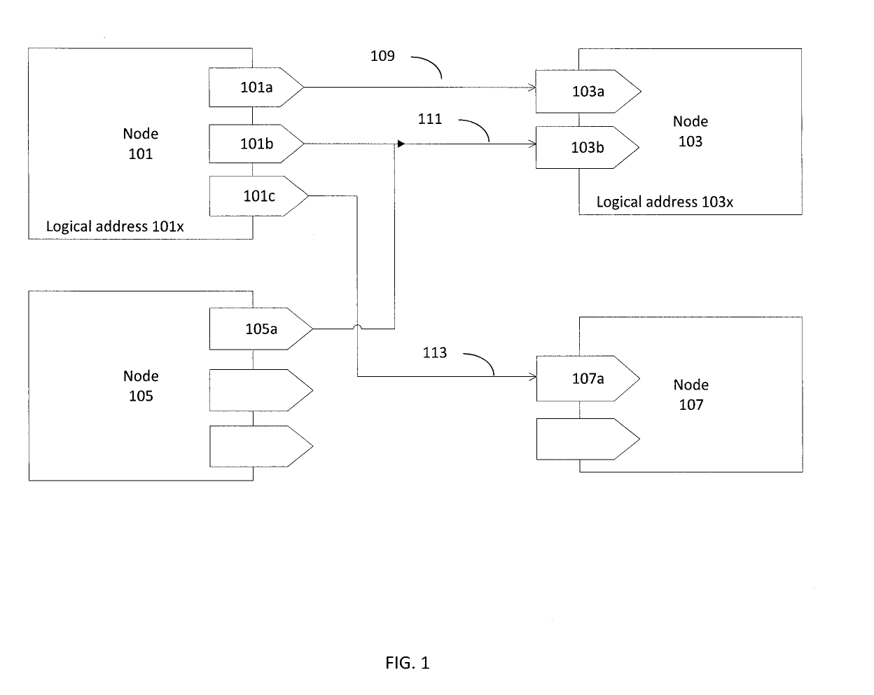

Improved node control in a distributed peer-to-peer network is described herein. FIG. 1 shows a simple control network featuring four distinct nodes with each node associated with an application to provide a functionality on the network. Peer-to-peer control networks implement distributed control based on contracts between peers and established trust between peers regarding data exchanged between peers and data semantics. Additionally, the network's addressing and transport properties are such that a first peer can reach a second peer over the network.

Each participating node also obtains its own unique identity to enable data flow between peers. For example, physical node 101 has a logical identity 101x associated with it and physical node 103 has a logical identity 103x associated with it. In some embodiments, the logical identity is the same as the physical identity and nodes address each other through unique physical aspects such as unique MAC-ID numbers. In most networks, logical addressing is used to abstract device identity, as it allows for device replacement and supports network topology. Systems using logical addressing obtain and apply a suitable and unambiguous logical address to each node. In either system, nodes address each other using the chosen form of addressing.

FIG. 1 illustrates an exemplary control network featuring four peer nodes 101, 103, 105, and 107 and their communication paths 109, 1011, and 113 in a distributed peer-to-peer network. While not illustrated, each node is associated with an application stored in local memory to execute on a processor associated with the node.

Each node is a logically addressable unit. Each node is associated with a single application. In some embodiments, a node is analogous to a physical device on the network. This physical device is addressable through the node's logical address. In other embodiments, each physical device contains multiple nodes (also known as logical devices). In such a case this application may be associated with multiple nodes. Each logical node in such a device may provide a separate function for the physical device.

Node 101 includes data output points 101a, 101b, and 101c. Through data output points 101a-c, applications of node 101 communicate with node 103 and its corresponding data input points 103a-b and node 107 and its corresponding data input point 107a. In some embodiments, the applications on each node establish connections with applications on other nodes by identifying the communication path between them, such as the communication path 109, instead of having to know about which data output or input point to connect to. This pathway is identified during the formation of a contract between the applications associated with the nodes.

Data is exchanged between one or more data sources, implemented as data output points, and zero or more data destinations, implemented as data input points. The data transfer is transparent to the application regardless of the number of or locality of data sources and destinations. This includes cases where no data destination is subscribed. Therefore, this description refers to communication and data exchange between two or more nodes by way of example, and it is understood that data exchange generally occurs between data sources and destinations.

The communications between nodes include, but are not limited to, one or more of: a data output, a poll request, and other data as needed to enable communication of information between the different nodes. In some embodiments, each node may receive communications from multiple nodes. For example, node 103 receives input at 103b from applications associated with node 101 and with node 105.

Nodes may be added to, or removed from, the network. A node will join the network and may automatically assign itself a unique address. The node may also automatically detect invitations for contract establishment, or proactively invite others to establish a contract of data exchange. Contracts between the node and other nodes will allow the node to send and request communications between itself and the other nodes. This simplifies installation of devices and reduces cost; the integration of these services enables the creation of such devices at virtually no cost to the developer. In some embodiments, a central arbitrator is also supported (not pictured). This central arbitrator allocates and assigns unique logical addresses to peers or nodes on the network instead of having the nodes assign addresses automatically to themselves.

Contract offer and acceptance are abstracted by a framework component contained in each node, thereby concealing the required low-level details from an application developer. This simplifies development and reduces cost and time-to-market of distributed control applications. By supporting intrinsic contract management services, the need for dedicated integration when forming a network of distributed applications is greatly reduced, and in many cases eliminated.

Instead of requiring the application developer to understand the low level details of each node or device, the framework component of each node automatically converts and conditions data from other nodes and its own application, for any supported data type. For incoming data, the data is converted by the framework component from a network compatible format to an application compatible format based upon stored data type information. For example, an integer value may be converted from the network endian (byte-order) format to the application endian format. The data is further conditioned by the framework based on stored metadata rules. For example, the same integer value may refer to a temperature value, and may be constrained to a particular range based on the stored metadata rules. An exemplary framework component is detailed below.

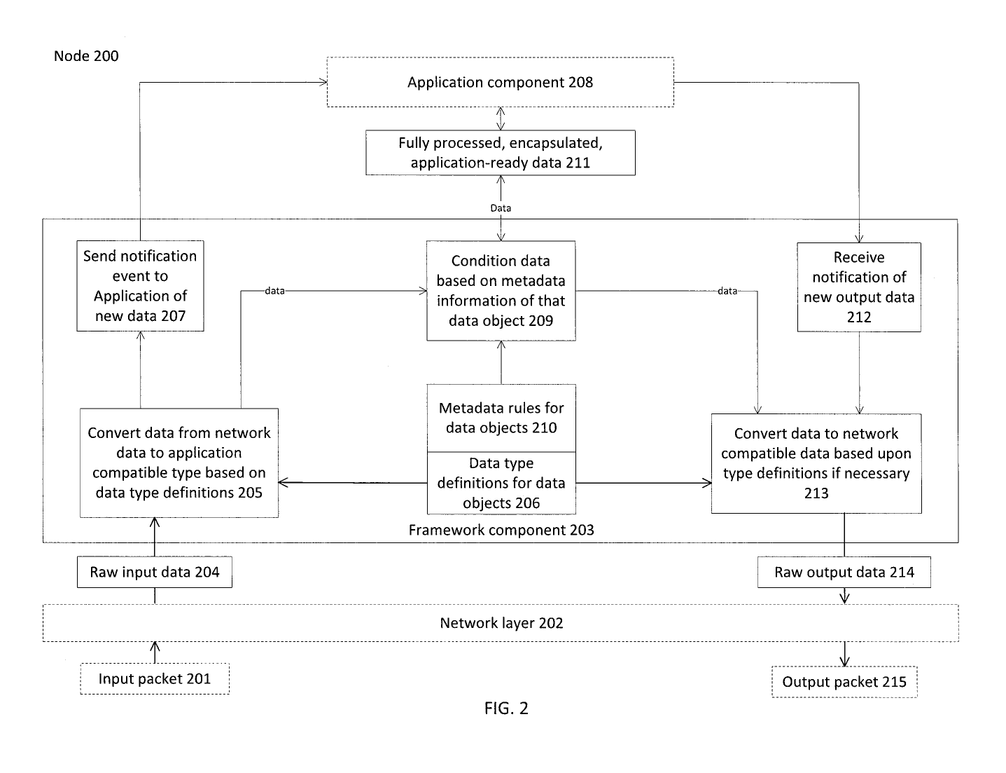

FIG. 2 illustrates the processing of data in a node according to an embodiment of the invention. An input packet 201 enters the network layer 202 which forwards this to the framework component 203 as raw input data 204. The framework component 203 converts this raw data at 205 from a network compatible data type to an application compatible data type at 205. Based on previously established contracts made with various nodes, the framework component 203 can identify the type of data being received. The framework component 203 then checks the stored data type definitions 206 to retrieve the type definition which identifies this raw data so that it can convert the raw data to an application compatible type. For example, a data type definition could identify the incoming raw data as an IEEE 754 double-precision floating point value encoded in big endian byte order so that this raw data is converted to little endian byte order and placed in a data object to be later passed to the application component 208.

At 209, the data is conditioned. The conditioning is based upon stored metadata rules 210. These metadata rules may be preconfigured or may be received from other nodes during contract formation. The metadata rules apply additional constraints to the data. For example, one rule may define the scale of a received value; i.e. a received value of 3000 may in fact represent an actual value of 300.0 degrees. As another example, another rule may apply a range limitation, for example to limit Celsius temperature values to be greater than −273.15 C. As yet another example, temperature values may be presented on the network as a big-endian 16-bit unsigned integer value implementing a fixed-point data ranging from 0 . . . 655.35 C with a resolution of 0.01 C, but may be presented to the application a floating point value, with transformation between network and application-facing data types, range and resolution limitations automatically applied by this framework. At 207, the framework component 203 sends a notification to the application component 208 letting it know that there is new data to utilize.

At 211, this converted and conditioned data is fully processed and encapsulated for the application 208 to utilize. The application does not need to perform additional conversion. For example, the application does not need to discover which node the raw data arrived from, or determine which part of the data corresponds to which data element, or which rules might need to be applied to that data. Thus, the application developer can focus on the primary functional aspects of the application instead of developing these data conversion processes.

At 212, once data has been processed in the application component 208, a notification may be sent to the framework component 203. Alternatively, the framework component is automatically notified when it detects that the application component has modified the data, such that the application layer need not actively send out a notification to the framework component. The framework component receives the data and conditions it at 209 so that it adheres to the metadata rules for that particular data type of the receiving application. In one embodiment, the data is queued before the framework component processes it.

At 213, in one embodiment, the data object which is output from the application component 208 and which has been conditioned by the framework component at 209 is converted into a network compatible format. For example, an integer value in little endian byte order may be converted into a network compatible big endian byte format. Once the data is converted, it is output as raw output data 214 for network layer 202 to output as an output packet 215 destined for other nodes.

In another embodiment, when the data output from the application component 208 is a request for a poll transaction, there is no need for a conversion or conditioning to take place as no data values are being output to the other nodes. Instead, the framework component 203 requests the network layer 202 to send a polling request to another node (not shown). For example, such a polling request could be periodically submitted to another node to determine if an event has occurred, or may be made to check if input data is now available from an input device, etc.

In some embodiments, the application component 208 only receives data and does not provide any output data. In such an instance, the framework would function to convert and condition the input data, and would not condition or convert any output data. In other embodiments, the application only outputs data, and thus the framework would not convert or condition any input data for the application.

In one embodiment, the framework component utilizes Python programming language constructs, of which one characteristic is that Python is not statically typed. In Python, data is accepted by operations within the language so long as the data can satisfy that particular operation. This is known in the art as duck typing. Thus, when the application component communicates with the framework component using logic developed with Python, there is no need to verify that the data objects that are communicated are of a particular type. This can greatly simplify the development of the logic within the application component. The framework component may further be developed to include additional runtime type identification techniques, which would in addition to the dynamic typing abilities of the Python language allow the application developer to develop applications with relative ease compared to frameworks developed in a statically or strongly typed programming language. Other programming languages that have the same or similar functionality may also be used. Furthermore, other programming languages which are not statically typed, or which are intrinsically polymorphic, may also be used.

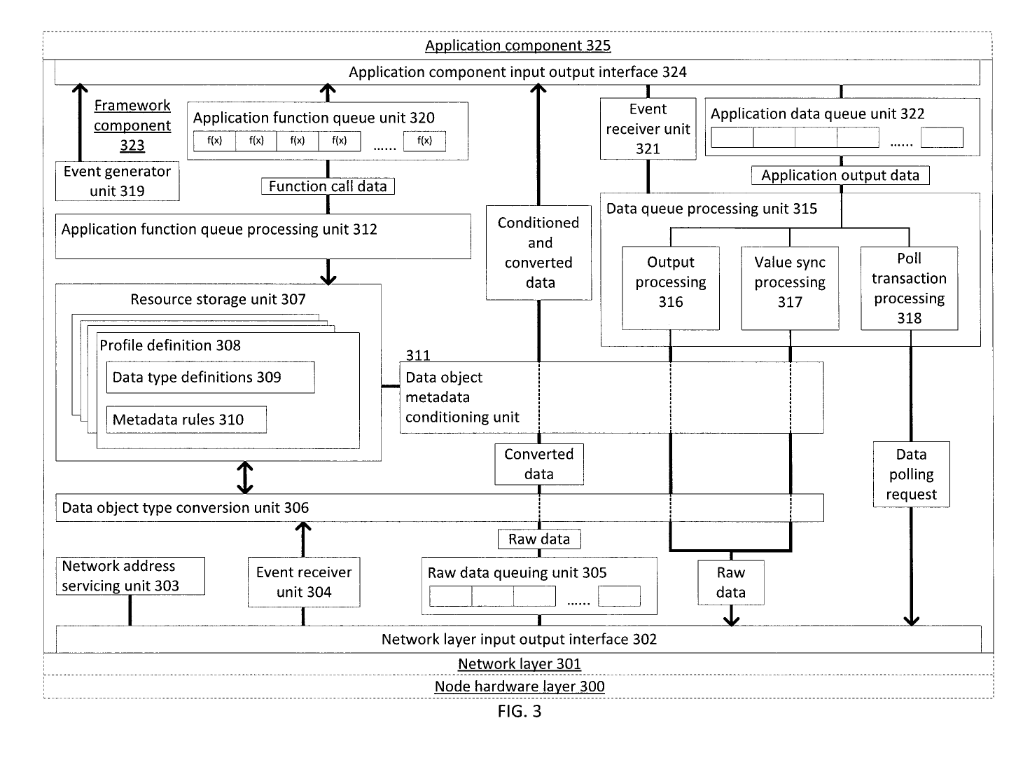

FIG. 3 is a block diagram of the framework component utilized by a node application according to one embodiment. The application component 325, the framework component 323, and the network layer 301 collectively execute on the node's hardware. The node's hardware may comprise a variety of network-enabled devices. For example, the device could be a carbon dioxide (CO2) sensor, a temperature sensor, a display, etc. The node will typically operate according to instructions stored within the application and framework components. The framework component 323 allows an application developer to develop the application component 325 without requiring detailed knowledge of the low level functions of the node's hardware.

Raw data enters through the network layer 301 from the network (not shown). An event receiver 304 is notified of this new data event and sends a service signal to the data object type conversion unit 306. This conversion unit 306, upon receiving a notification of new incoming data, services the raw data queuing unit 305 and processes the data queued up within it. In some embodiments, the data arrives directly at the conversion unit 306 without being queued. The conversion unit 306 converts the raw data in the queuing unit from a network compatible data format to an application compatible data format, based on the data type definitions 309 stored within the resource storage unit 307. The storage unit 307 provides the conversion unit 306 with information on how to transform the values. For example, the information provided by the storage unit 307 may direct the conversion unit 306 to convert a big endian byte order formatted integer value to a little endian bye order formatted integer value, etc.

After the data is converted to an application compatible data format, it is further conditioned by the data object metadata conditioning unit 311. Based on the metadata rules 310 provided by the storage unit 307, the conditioning unit 311 applies these various rules to the converted data. For example, the rules 310 may indicate that the converted data which the conditioning unit 311 has received is a temperature value, and that the temperature value should not fall below −273.15 Celsius. The conditioning unit 311 may apply no rules, a single rule, or multiple rules upon a data object based upon the information provided by the storage unit 307. After the data passes through the conditioning unit 311, it is sent to the application component 325 through the application component input output interface 324 for the application to use. In some embodiments, the event generator unit 319 generates an event to notify the application component 325 to expect new data.

In some embodiments, the resource storage unit 307 receives the data type definitions 309 and the metadata rules 310 from a profile definition 308. Each profile 308 may contain a set of data type definitions 309 and metadata rules 310 representing the types of data and the metadata that governs these data types and their relations within the profile. For example, the storage unit 307 may contain a profile for a CO2 sensor device, etc. As a further example, the CO2 sensor profile may describe the data type, and other attributes, of the principal data output point associated with this profile; e.g. a CO2 concentration in parts per million (ppm), ranging from 0 to 65535 ppm. The profile may designate one of many data output points as the profile's principal data output point. The profile may further specify a required property to describe the minimum value change required to permit retransmission of the principal data output, and the profile clarifies relations by defining that the minimum value change threshold applies to the principal data output, not to other data output points defined in the profile.

Each profile 308 may be stored in the storage unit 307 before the node is connected to the network, or the information to create or update such a profile may be received from another node after being connected to the network. The framework component 323 will automatically store such received profile information in the storage unit 307, or may only additionally store those profiles for which it was configured to store. Furthermore, the profiles may be stored in a flat file format or in a database. The profiles may be described using source code, or they may be described in an alternative format.

Periodically, the framework component 323 checks the application function queue unit 320 to see if the application has requested any function calls. These function calls are processed via the application function queue processing unit 312. These function calls may be asynchronous, i.e., the application component will not wait on the processing unit 312 to complete processing of a function call stored in queue unit 320. In such a case, the function call does not return data to the application component.

If the application component 325 provides output, the framework component 323 will automatically be notified of the output when it detects that the data object containing the output has changed. Alternatively, the application component 325 sends a notification to the framework component 323 which will be received by the event receiver unit 321. The output will also be placed in the application data queue unit 322. The data queue processing unit 315 processes the output within the queue unit 322. In some embodiments, that output is directly sent to the processing unit 315 without being queued.

The output comprises at least three types: an output request, a value sync, and a poll transaction request. When the processing unit encounters an output request, it sends the output data from the application component to the conditioning unit 311 to have the metadata rules applied to it based on information stored in the storage unit 307. The output is further converted to a network compatible format at conversion unit 306. The processing unit determines whether the output is marked as polled at output processing 316. If this is not the case, the output data is sent to the network layer 301 for propagation into the network. This data may be directed to no data destination if a contract is not established, or may be directed to one or more nodes in the network according to the established contract or contracts that apply to this data output point. If the data output us marked as polled, the data is then conditioned at conditioning unit 311 and at conversion unit 306 and is submitted to the network layer 301. However, the data is not propagated to another node. Instead, the data is stored at the network layer 301 such that other nodes may request this up-to-date data from the network layer.

If the processing unit 315 encounters a value synchronization, it directs data modified by the application component to value synchronization processing at 317. The data is then conditioned at conditioning unit 311 and at conversion unit 306 and is submitted to the network layer 301. However, the data is not propagated to another node. Instead, the data is stored at the network layer 301 such that other nodes may request this up-to-date data from the network layer.

If the processing unit 315 encounters a poll transaction request, it sends a request to the network layer for a poll transaction according to the contact or contracts which apply to the corresponding data input point.

In one embodiment, the node assigns itself a unique address via the network address servicing unit 303. Periodically, the framework component 323 services this network configuration information at the network address servicing unit 303. This process is transparent to the application component 325.

In one embodiment, the node automatically detects other nodes in the network, and stores the addresses of the other nodes and the routing information of the network for use by the application.

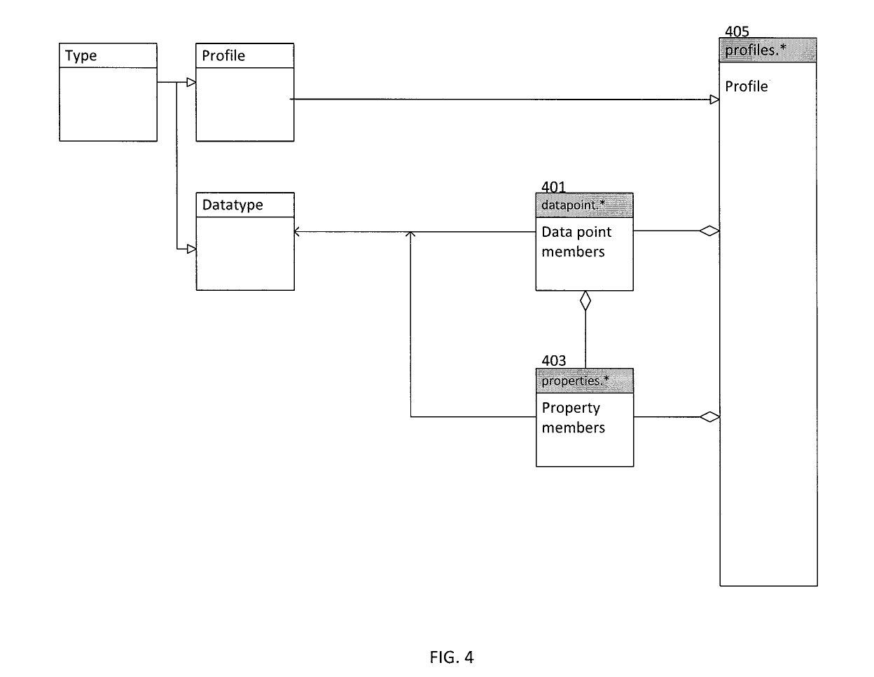

FIG. 4 illustrates resource definition types according to one embodiment of the invention. These resource definition types may be stored in the resource storage unit 307 as shown in FIG. 3. At least three types of resource definitions are supported: the profile 405, the data point members 401, and the property members 403. As shown in FIG. 4, each profile 405 contains zero or more data point members 401 and zero or more property members 403. Zero or more property members 403 can apply to the profile 405 as a whole, and zero or more property members 403 can apply one of the data point members 401 of the profile 405. The data point members 401 define resource values for the profile. For example, a data point member may define a CO2 parts per million value for a CO2 sensor profile. The properties 403, of which zero or more may be associated with each data point, provide rules governing the data points members 401 and/or of the profile as a whole. For example, one such property could control the minimum value change in the CO2 concentration required to permit the transmission of an updated data output value from this sensor profile.

In some embodiments, the data point and property members and metadata provided therein are used by conversion unit 306 to convert data between the application and the network. Metadata rules which are contained in the data point members 401 and property members 403 are used by the conditioning unit 311 to condition data. For example, the metadata rules could be used to limit the value range of a data point.

As noted previously, each profile 405 contains the data point members and property members, metadata, and relationships for a given functionality. For example, one profile might define the network presentation of a CO2 sensor, including its data output points and properties, their data types and metadata and the relationships between the property members, the data point members and the profile. Furthermore, each data point and property member may be designated as mandatory or optional. If the member is optional, then that member need not be configured for the device to effectively function in the network. Each data point or property member may be comprised of a wide variety of data types, including, but not limited to, an enumerated value, a reference, a scaled value, a floating point value, an aggregate data type, such as a structure or a union data type, or an array data type.

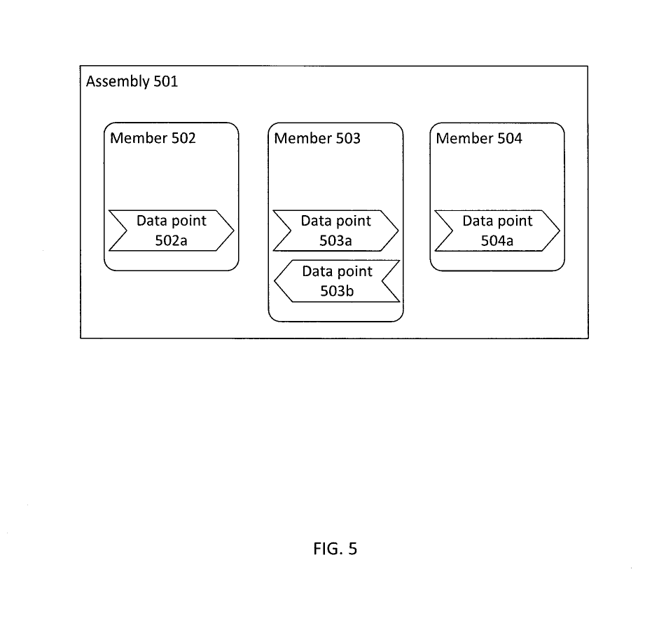

FIG. 5 illustrates an assembly data object used to implement a contract between different nodes according to one embodiment of the invention. When establishing a contract, the application in the invention declares an assembly object, such as the assembly 501 depicted in FIG. 5. In some embodiments, an application also declares an enrollment data object (not shown), which provides additional data used for the establishment of a contract such as the number of assembly members, the data types or data categories, etc. An assembly object is an application-specific way of grouping data point objects for the purpose of establishing and maintaining a data exchange contract. The assembly object contains a set of members, such as the members 502, 503, and 504. These members correspond to a grouping of particular data variables related to separate functional areas within a node. Each member further contains a non-empty list of data point references, for example data points 502a, 503a-b, and 504a. These data points are representations of those particular data variables. As detailed above, data points may be defined in a profile, and may also be constrained by metadata rules. An application developer can design the application component 325 to declare the particular data points for an assembly or provide the more abstract description of a data exchange contract with an enrollment object, but does not need to understand low level or protocol specific details in order to create the assembly (or declare the enrollment data object in some embodiments), as these details are automatically generated by the framework component 203.

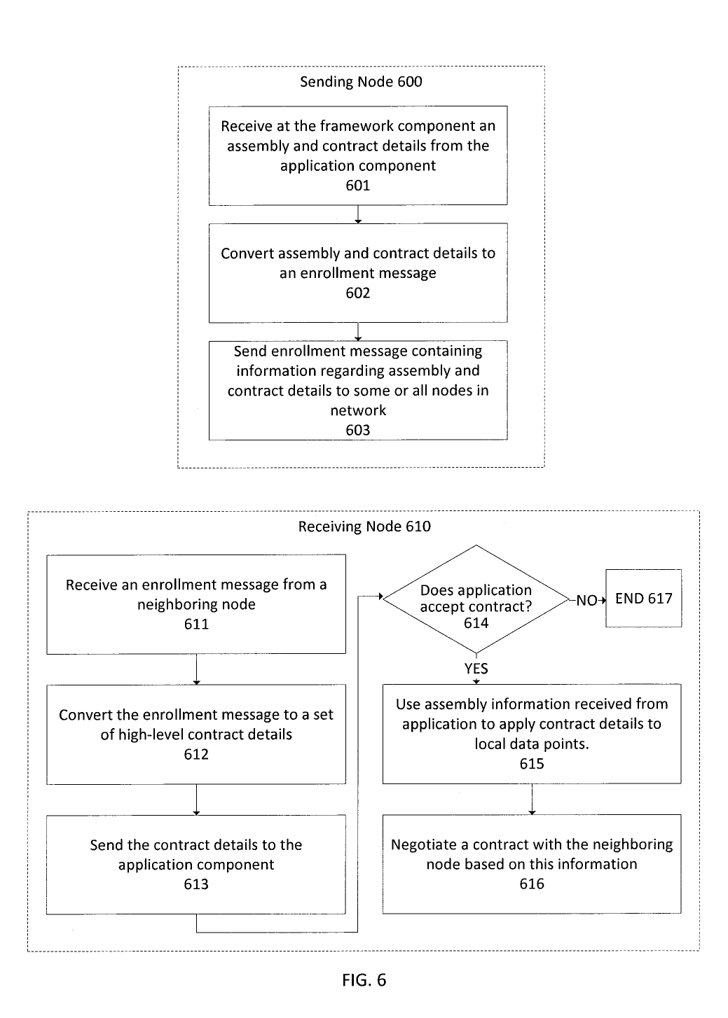

FIG. 6 is a flow diagram illustrating the details of contract formation between two nodes according to one embodiment of the invention. In this embodiment, a first node 600 advertises its abilities to the other nodes in the network. The application component on the first node 600 is configured to provide an assembly and contract details containing the data points and other details and properties which the first node 600 wishes to advertise to other nodes in the network. For example, a CO2 sensor node may advertise that it can provide CO2 concentration readings at a particular interval time, along with the properties of the data and additional information which may be required to form a new contract with the CO2 sensor. On the first node 600, at 601, this information is received by the framework component from the application component. At 602, the framework component of the first node 600 consults low level implementation and protocol details in order to convert the high level assembly object and contract details to an enrollment message. At 603, this enrollment message is sent to all or some nodes in the network.

The second node 610 receives the enrollment message from the first node 600 at 611. At 612, the second node 610, using its framework component, converts the low level enrollment message to a high level enrollment object. The enrollment object provides the details of the contract in a presentation which may be understood by the application component on the second node 610 without knowledge of the low level protocol details. At 613, this information is sent to the application component of the second node 610.

The application component contains instructions as to whether to accept or reject the contract. For example, an environment monitoring device may be designed to accept contracts with devices which can indicate aspects of air quality. Such a system may accept a contract with a newly added CO2 sensor. In some cases, the instructions which decide whether to accept a contract are provided by the application developer. In other cases, they may be provided automatically when the included resource definitions for the device on which the application component resides upon are utilized. This decision is made at 614.

If the application decides not to accept the contract, it provides no assembly objects, and execution ends at 617. If the application component decides to accept the contract, it can provide one or more assembly objects to the framework component. The framework can use the information in the assembly objects to apply the data points from the first node 600 to local data points at 615. For example, if the second node is a fire alarm system, the application component may provide instructions stating that if data from the CO2 sensor indicates CO2 levels above a certain level, then activate an alarm feature on the fire alarm system. The framework component of the second node 610 can understand the high-level instructions provided by the application component and apply them to the device using low-level device specific instructions.

At 616, the framework component of the second node 610 communicates the details of the contract to the first node 600. For example, the framework component may communicate a message to the sending node indicating acceptance of the contract, and may request from the sending node that data be sent according to certain parameters. In one embodiment, this process is fully automated by the framework component. In another embodiment, this process is semi-automated, and allows the application to affect its execution, typically based on user input.

In some embodiments, contracts may be formed not only between two or more nodes, but between data points within a node. Furthermore, the assembly, enrollment, and contract details would be associated with data points on the same node.

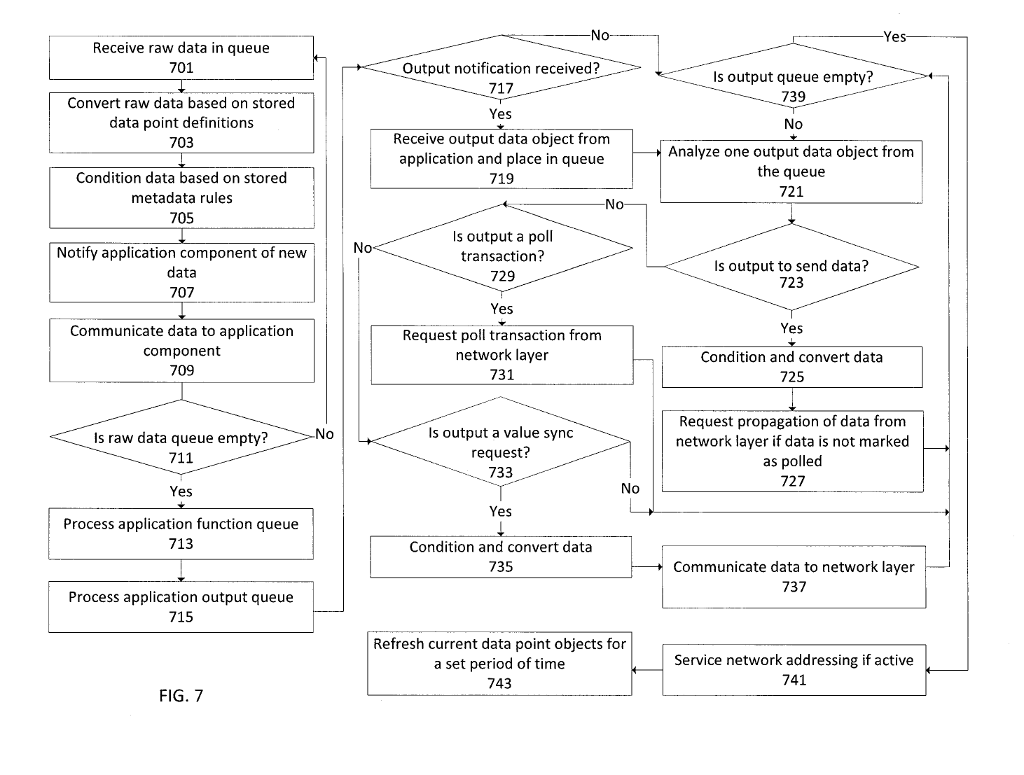

FIG. 7 is a flow diagram illustrating data processing according to one embodiment of the invention. At 701, the framework component 323 receives raw data 204 from the network layer 301 into queue 305. For example, the raw data could be a CO2 level from a CO2 sensor, etc. At 703, the framework component converts the raw data 204 to an application compatible data format according to the stored data type definitions 309. For example, the CO2 level may be converted from a big endian network byte order format to a little endian application compatible format. In some embodiments, this conversion is performed by conversion unit 306. At 705, the data is further modified by constraining and conditioning the data according to stored data property definitions 310. For example, the temperature value may modified so that it cannot fall below absolute zero. In some embodiments, this conditioning occurs via conditioning unit 311. At 707, an event notification is sent to the application component for the new data. In some embodiments, this event notification is generated by event generator unit 319. At 709, this converted and conditioned data is presented to the application component 325.

In some embodiments, the framework component supports concurrent processing. In such a scenario, once the data object is presented to the intended application component thread, the data object may optionally be locked such that other application component threads are prevented from modifying the data until the intended application component thread completes processing on that data object.

At 711, the raw data queue 305 is checked by the framework component 323 to see if it is empty. Execution proceeds to 701 to process additional raw data items if the queue is not empty. Execution proceeds to 713 otherwise. At 713, any function calls generated by the application component 325 are processed by the framework component 323. In some embodiments, these function calls are stored in function queue 320, and are processed via the function queue processing unit 312 within the framework component 323. The application component 325 may rely on methods stored within the framework component 323 to execute the various function calls.

At 715, the application output queue 322 is processed by the framework component 323. At 717, the framework component 323 first checks to see if any notification of output has been received from the application component 325. In some embodiments, this notification is received by event receiver unit 321. If a notification has been received, execution continues to 719. Otherwise, execution continues to 739. If no notification was received, and at 739, the application output queue 322 is determined to be empty by the framework component 323, execution continues to 741.

If an output notification is received by the framework component 323 from the application component 325, the output is placed in the application queue 322 by the framework component 323 in an embodiment. In some embodiments, the application component does not explicitly notify the framework component of new output. Instead, the framework component is implicitly notified when new output is received from the application component. For example, the framework component 323 may be implicitly notified when new data is placed in the application queue 322. In other embodiments, more than one output item is received at once from the application component 325. In such a case, all the received items are placed in the queue.

At 721, the output is analyzed to determine the type of output the application has sent. If the output is a data object which should be sent to another node, then the conditional of 723 answers in the affirmative and the process proceeds to 725. At 725, the output data is conditioned based on the stored property definitions 310, and is converted into a network compatible format based on the data type definitions 309. In some embodiments, these operations are executed by conditioning unit 311 and conversion unit 306, respectively. At 727, the framework component requests that the network layer propagate this data, if the data is not marked as polled. If the data is marked as polled, no propagation is requested.

If the output is determined to be a poll transaction, then the conditional of 729 is answered in the affirmative. The framework component sends a poll transaction request to the network layer in 731 in such a case.

If the output is determined to be a value synchronization request, then the conditional of 733 is answered in the affirmative. Execution then proceeds to 735, where the data modified by the application component will be conditioned, and then converted, respectively, in the same fashion as in 725. The data is then sent to the network layer by the framework component 323 in 737. The data is not propagated into the network. Instead, another node which polls the network layer for this data receives this up-to-date and synchronized data. If the output is not determined to be a value synchronization request, nothing is done to the request and execution proceeds to 739 to process any additional requests in the output queue. In other embodiments, the framework component may be designed to support additional output types, such as other forms of message frames, and would not be limited to the three types described here. In such an case, if the output is not determined to be a value synchronization request, the output would be checked by the framework component $C23 to see if it is one of these other types of requests.

After one output item from the application component is processed, the framework component 323 continues to process remaining output until the queue 322 is emptied. Thus, processing will resume at 739 until the queue is empty. Once the queue 322 is emptied, execution proceeds to 741.

Optionally, the framework component 323 may also service the network addressing and routing data at 741. For example, the framework component can monitor the network for logical address conflicts and act to resolve them. In some embodiments, this operation is performed by the network address servicing unit 303. If no servicing occurs, then execution immediately moves to 743.

At 743, the framework component 323 refreshes current data point objects for a set period of a time. The framework component's knowledge of some low level aspects of data point objects, defined by 401, along with their data properties 403, may change as a result of a new contract establishment with a new node, or a maintenance activity performed on the data object, or other operation, including a network management operation performed by another party. In one embodiment, the framework component 323 processes these objects in a round-robin fashion, for a set period of time. Once that time expires, the framework component 323 pauses the refreshing of these objects and continues with a separate in its operation, such as 701 of FIG. 7. When the framework component 323 reaches 743 once again, it resumes the refreshing of these objects at the point which it had previously left off. Once the entire list of relevant data point objects are processed, the framework component 323 continues the refreshing of the data point objects starting with the beginning of the list.

Although the process shown in FIG. 7 assumes that an application component accepts input and output data, this may not always be the case. Some applications may only receive data, some may only output data, and some applications may do neither. For such an application, the framework component will not perform the related operation. For example, an application may only require the framework component to process function calls, and neither sends nor receives data. In such a case, the framework component would not convert or condition data, but would instead simply process function calls from the application.

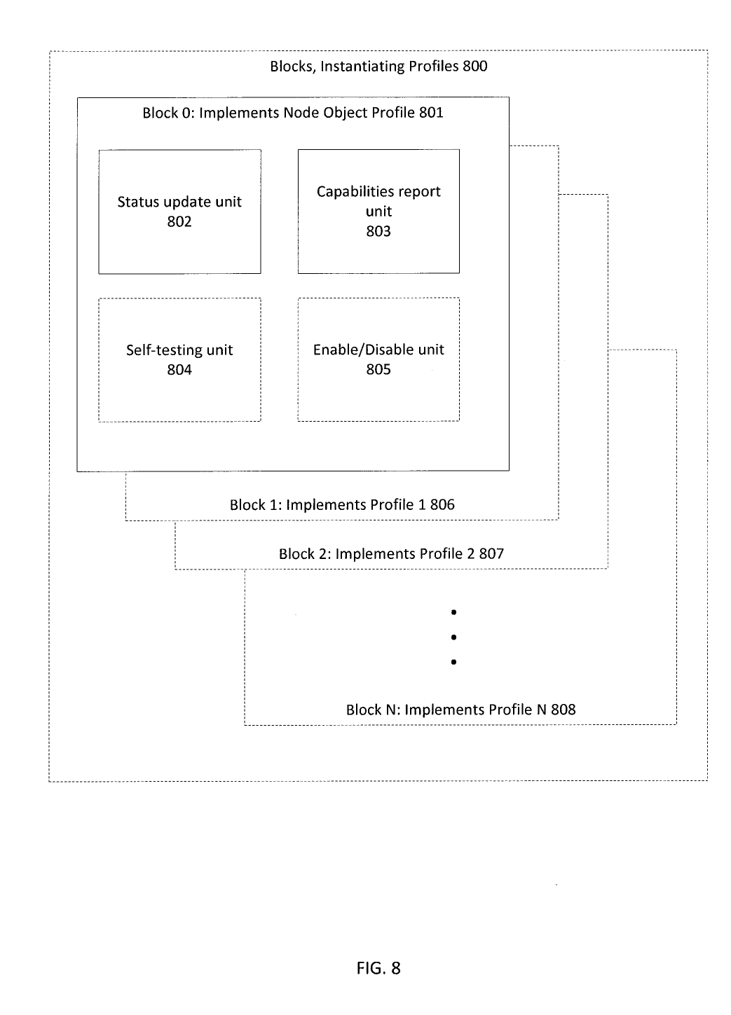

FIG. 8 illustrates instantiated stored profiles which have been called by the application component according to one embodiment of the invention. In one embodiment, the application component imports a profile definition 308 stored in the resource storage unit 307. Once the application component imports the profile definition, the framework component 323 instantiates the profile in a block object. Subsequently, output and input data associated with the device type that this instantiated profile represents is stored in this instantiated object. Any functions related to that profile are also called using that instantiated object. For example, an application component 325 may import the definition of the CO2 sensor profile to supply readings from an attached physical CO2 sensor to the network. The framework component 323 then instantiates a copy of the CO2 profile. Any properties and values related to the CO2 sensor will subsequently be stored in this instantiated copy. The application component may then access these values and properties through methods associated with this instantiated profile object.

In one embodiment, the application component 325 instantiates profiles. These multiple profiles are stored in logical block units, for example, as blocks 806, 807, and 808. However, the framework component 323 also instantiates a special node object profile 801. This node object instance provides various housekeeping and maintenance operations for the node. For example, the node object provides a status update function in unit 802. The node object provides a capabilities report function in unit 803. The node object may also optionally provide an enable disable function in unit 805, and optionally provide a self-testing function in unit 804. The functionality of the node object 801 is not limited to these described, and may include additional maintenance and housekeeping functions as well. Many of these functions may enable the node to function and communicate properly in the network. Since these functions have been previously implemented in the node object profile, the application developer need not be concerned with implementing them inside the application component, thus reducing mandatory application overhead.

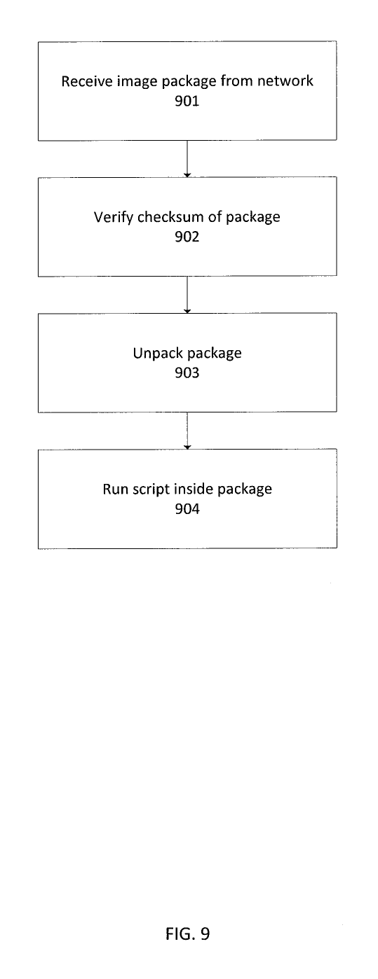

FIG. 9 is a flow diagram illustrating the processing of application upgrades according to one embodiment of the invention. At 901, the framework component receives the upgrade image from the network. At 902, the framework component verifies the checksum of the package containing the upgrade image. The package may have been additionally sent to the node in multiple fragments. In such a case, the framework component assembles these fragments and verifies a separate checksum to ensure that the assembly was done correctly. This assembly operation can be optionally carried out directly on the network layer.

At 903, the image package is unpacked, and at 904, the installation script within the image package is executed. 903 and 904 can optionally be executed on the application component instead. In such an instance, the framework component would send the package, which has had its checksum verified, to the application component, and the application component would then perform 903 and 904.

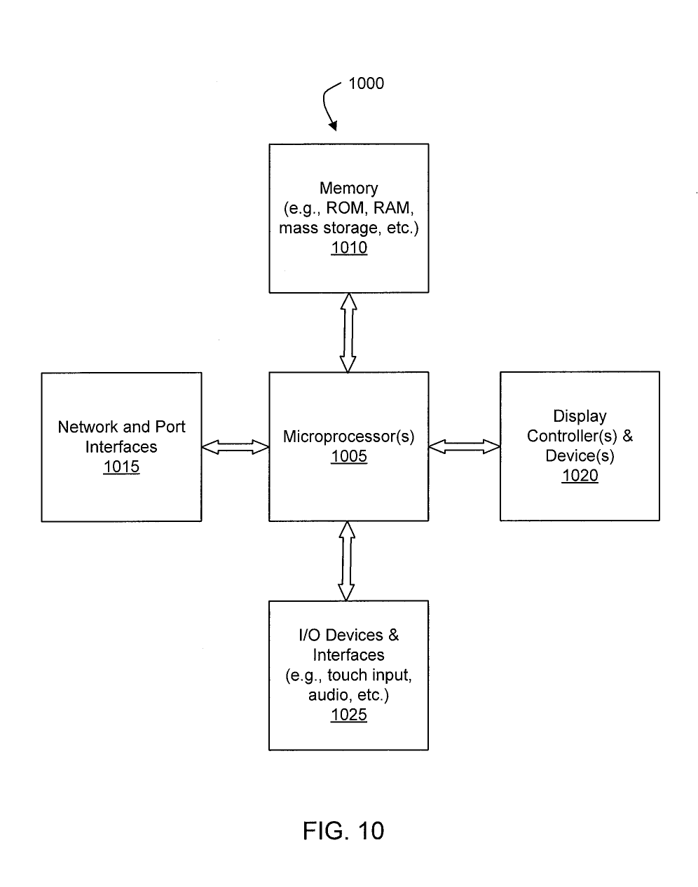

FIG. 10 illustrates, in block diagram form, an exemplary processing system 1000 such as a device or a node. Data processing system 1000 includes one or more microprocessors 1005 and connected system components (e.g., multiple connected chips). Alternatively, data processing system 1000 is a system on a chip.

Data processing system 1000 includes memory 1010, which is coupled to microprocessor(s) 1005. Memory 1010 may be used for storing data, metadata, and programs for execution by the microprocessor(s) 1005. For example, memory 1010 may include one or more of the data stores 101 and/or may store modules described herein. Memory 1010 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1010 may be internal or distributed memory.

Data processing system 1000 includes network and port interfaces 1015, such as a port, connector for a dock, or a connector for a USB interface, FireWire, Thunderbolt, Ethernet, Fibre Channel, etc. to connect the system 1000 with another device, external component, or a network. Exemplary network and port interfaces 1015 also include wireless transceivers, such as an IEEE 802.11 transceiver, an infrared transceiver, a Bluetooth transceiver, a wireless cellular telephony transceiver (e.g., 2G, 3G, 4G, etc.), or another wireless protocol to connect data processing system 1000 with another device, external component, or a network and receive stored instructions, data, tokens, etc.

Data processing system 1000 also includes display controller and display device 1020 and one or more input or output (“I/O”) devices and interfaces 1025. Display controller and display device 1020 provides a visual user interface for the user. I/O devices 1025 allow a user to provide input to, receive output from, and otherwise transfer data to and from the system. I/O devices 1025 may include a mouse, keypad or a keyboard, a touch panel or a multi-touch input panel, camera, optical scanner, audio input/output (e.g., microphone and/or a speaker), other known I/O devices or a combination of such I/O devices.

It will be appreciated that one or more buses, may be used to interconnect the various components shown in FIG. 10.

Data processing system 1000 is an exemplary representation of one or more of the devices described above. Data processing system 1000 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In other embodiments, data processing system 1000 may be a network computer, server, or an embedded processing device within another device or consumer electronic product. As used herein, the terms computer, device, system, processing system, processing device, and “apparatus comprising a processing device” may be used interchangeably with data processing system 1000 and include the above-listed exemplary embodiments.

Additional components, not shown, may also be part of data processing system 1000, and, in certain embodiments, fewer components than that shown in FIG. 10 may also be used in data processing system 1000. It will be apparent from this description that aspects of the inventions may be embodied, at least in part, in software. That is, the computer-implemented method(s) may be carried out in a computer system or other data processing system 1000 in response to its processor or processing system 1005 executing sequences of instructions contained in a memory, such as memory 1010 or other non-transitory machine-readable storage medium. The software may further be transmitted or received over a network (not shown) via network interface device 1015. In various embodiments, hardwired circuitry may be used in combination with the software instructions to implement the present embodiments. Thus, the techniques are not limited to any specific combination of hardware circuitry and software, or to any particular source for the instructions executed by data processing system 1000.

The details described above remove the need for the application to provide the necessary supporting logic to allow the node to interact with other nodes. Instead, the application developer may focus specifically on the logic needed for the node to perform its desired function. An advantage of these features is that an application developer no longer needs in depth knowledge of how multiple devices function internally, and thus the application developer may develop an application much faster than before.

Different embodiments of the invention may be implemented using different combinations of software, firmware, and/or hardware. Thus, the techniques shown in the figures can be implemented using code and data stored and executed on one or more electronic devices (e.g., an end system, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device.

While the flow diagrams in the figures herein above show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method comprising:
receiving input data from the network at a first node;
converting the input data to an application compatible data based on data type definitions stored in the first node;
conditioning the application compatible data to be compatible with an application of the first node using meta data rules stored in the first node;
sending the conditioned application compatible data to the application of the first node for processing; and
sending an event notification to the application of the first node to indicate that conditioned application compatible data is available for processing.

2. The method of claim 1, further comprising:
queuing the input data into a raw data queue before converting the input data.

3. The method of claim 1, wherein the conditioned application compatible data requires no additional conversion by the application.

4. The method of claim 1, wherein the conditioned application compatible data is encapsulated into a data object prior to sending the conditioned application compatible data to the application of the first node for processing.

5. The method of claim 4, wherein the data type definitions and meta data rules are derived from a profile.

6. The method of claim 5, wherein the meta data rules defines a plurality of rules for interpreting the application compatible data.

7. The method of claim 5, wherein the profile is instantiated into a list of at least one data blocks.

8. The method of claim 7, wherein a node object is automatically instantiated in the list of data blocks to provide maintenance and housekeeping operations.

9. The method of claim 1, where the method is implemented in Python programming language.

10. The method of claim 1, further comprising:
receiving an output from the application of the first node, wherein the output data is an output request;
conditioning output data received from the application based on the meta data rules stored in the first node;
converting the output data to a network compatible data based on the data type definitions; and
sending the network compatible data to the network compatible data to all contracted subscribers.

11. The method of claim 1, further comprising:
receiving an output from the application of the first node, wherein the output is a poll transaction request; and
requesting a poll transaction from the network.

12. The method of claim 1, further comprising:
receiving an output from the application of the first node, wherein the output is a value synchronization request;
conditioning data based on the meta data rules stored in the first node, wherein the data is input data previously modified by the application;
converting the data to a network compatible data based on the data type definitions; and
storing the data on a network layer of the first node.

13. A first node comprising:
a processor; and
memory to store an application and a data alteration framework, wherein when the data alteration framework is executed by the processor, the processor performs operations comprising:
receiving input data from a second node at a first node;
converting the input data to an application compatible data based on data type definitions stored in the first node;
conditioning the application compatible data to be compatible with an application of the first node using meta data rules stored in the first node;
sending the conditioned application compatible data to the application of the first node for processing; and
sending an event notification to the application of the first node to indicate that conditioned application compatible data is available for processing.

14. The first node of claim 13, wherein the conditioned application compatible data requires no additional conversion by the application.

15. The first node of claim 13, wherein the conditioned application compatible data is encapsulated into a data object prior to sending the conditioned application compatible data to the application of the first node for processing.

16. The first node of claim 15, wherein the data type definitions and meta data rules are derived from a profile.

17. The first node of claim 16, wherein the meta data rules define a plurality of rules for interpreting the application compatible data.

18. The first node of claim 17, wherein the profile is instantiated into a list of at least one data blocks, wherein the instantiation occurs within the data alteration framework.

19. The first node of claim 18, wherein a node object is automatically instantiated in the list of data blocks to provide maintenance and housekeeping operations fully and transparently for the application.

20. The first node of claim 13, the data alteration framework is implemented in Python programming language.
